(19) United States
(12) Patent Application Publication
(10) Pub. No.: US 2024/0063552 A1
(43) Pub. Date: Feb. 22, 2024

(54) DUAL-POLARIZATION HIGH-ISOLATION CASSEGRAIN ANTENNA

(71) Applicant: Nanjing University of Information Science & Technology, Nanjing (CN)

(72) Inventors: Junxiang GE, Nanjing (CN); Hai LIN, Nanjing (CN); Jie WANG, Nanjing (CN); Boyu QI, Nanjing (CN)

(21) Appl. No.: 18/454,421

(22) Filed: Aug. 23, 2023

Related U.S. Application Data
(63) Continuation of application No. PCT/CN2022/140664, filed on Dec. 21, 2022.

(30) Foreign Application Priority Data
Aug. 18, 2022 (CN) 202210991388.0

(51) Int. Cl. H01Q 19/19; H01Q 1/52; H01Q 13/02; H01Q 15/24

(52) U.S. Cl. CPC H01Q 19/19; H01Q 1/52; H01Q 13/02; H01Q 15/24

(57) ABSTRACT

Provided is a dual-polarization high-isolation Cassegrain antenna, including a main reflector, a secondary reflector and a diagonal horn feed. The diagonal horn feed includes an integrated cross-polarization coupling-structure and a diagonal horn protruding structure, where a hollow part of the diagonal horn protruding structure is diagonal horn-shaped, and a horn opening is upward. An edge line is arranged in the diagonal horn feed, and the edge line passes through the diagonal horn protruding structure and the cross-polarization coupling-structure. The cross-polarization coupling-structure includes a first port and a second port. The second port is located at a side surface of the diagonal horn feed, and an access is communicated with an edge line of a diagonal horn. The first port is located at a bottom surface of the diagonal horn feed.

### CROSS-REFERENCE TO RELATED APPLICATIONS

This disclosure is a continuation of PCT/CN2022/140664, filed Dec. 21, 2022 and claims priority of Chinese Patent Application No. 202210991388.0, filed on Aug. 18, 2022, the entire contents of which are incorporated herein by reference.

### TECHNICAL FIELD

The disclosure relates to the field of microwave and millimeter-wave radio frequency antennas, and in particular to a dual-polarization high-isolation Cassegrain antenna system applied to millimeter-wave weather radar and communication.

### BACKGROUND

Millimeter waves refer to electromagnetic waves with frequency ranges of 30-300 GHz, and are widely used in millimeter wave relay communication, radars, remote sensing and missile guidance.

At present, millimeter-wave weather radars mostly work at 35 GHz, 94 GHz, 140 GHz, 220 GHz, etc. as working frequency points. 140 GHz and 220 GHz are mostly in a basic research and development stage. At present, a main research and a main application are still concentrated in 35 GHz and 94 GHz. Compared with a millimeter-wave weather radar system at 35 GHz, a weather radar at 94 GHz has higher resolution, a smaller size and a stronger detection ability, and is of great significance for analyzing and retrieving an early cloud structure and cloud particle distribution, and is a hot spot in the research and the application at present. A dual-polarization radar may transmit and receive electromagnetic waves with two polarizations. Compared with a single-polarization radar, the dual-polarization radar may obtain scattering characteristics of a target in two vertical directions, which is of great significance to a detection and analysis ability of the radar and is a key point in the research and the application of weather radars.

An antenna is an important part of a radar system and a communication system, and a main function of the antenna is to transmit and receive radio frequency detection signals according to design requirements. In an application of a weather radar system, a dual-polarization antenna is required to have good high gain, a low loss, high isolation and high power characteristics, excellent cross polarization characteristics and a consistent radiation gain pattern of ports. General microstrip antennas or antennas based on new electromagnetic materials have large losses, high sidelobes, unsatisfactory gain and low power tolerance. A reflector antenna and a Cassegrain antenna have advantages of simple structures, high efficiency, low losses, small sidelobes, high gain and strong power resistance. Therefore, the antennas are still widely used in millimeter wave radars and remote sensing systems.

A circularly polarized antenna designed based on satellite communication mainly focuses on polarization characteristics of the antenna, but polarization isolation characteristics of ports of existing antennas are not high, and port isolation is low, which does not fully meet requirements of weather radar parameters.

### SUMMARY

In view of shortcomings of existing technology, an objective of the disclosure is to design a dual-polarization high-isolation Cassegrain antenna with a simple structure and a highly consistent port radiation direction for an application of a dual-polarization weather radar and millimeter-wave long-distance communication system.

In order to achieve above technical objectives, the disclosure adopts a following technical scheme.

A dual-polarization high-isolation Cassegrain antenna is provided, including a main reflector, a secondary reflector and a diagonal horn feed. The diagonal horn feed includes an integrated cross-polarization coupling-structure and a diagonal horn protruding structure, where a hollow part of the diagonal horn protruding structure is diagonal horn-shaped, and a horn opening is upward. An edge line is arranged in the diagonal horn feed, and the edge line passes through the diagonal horn protruding structure and the cross-polarization coupling-structure.

The cross-polarization coupling-structure includes a first port and a second port. The second port is located at a side surface of the cross-polarization coupling-structure, and its access is communicated with a side of the edge line. The first port is located at a bottom surface of the cross-polarization coupling-structure, and is communicated with a bottom of the edge line.

Further, an access of a second port left profile is provided with a matching structure of the second port left profile, and an access of a second port right profile is provided with a first matching structure of the second port right profile.

Further, a second matching structure of the second port right profile is arranged at a set distance from the access of the second port on the second port right profile.

Further, the secondary reflector is connected to a fixed disk, and the fixed disk is connected to the main reflector through a secondary reflector bracket structure.

Further, the secondary reflector bracket structure has four rhombic prisms, one end of each of the rhombic prisms is connected with the fixed disk, and an other end is connected with an edge of the main reflector.

Further, the diagonal horn feed includes a part connected with a fixed bottom plate, and the fixed bottom plate is used to install and fix the dual-polarization high-isolation Cassegrain antenna.

The disclosure has following beneficial technical effects.
(1) The dual-polarization high-isolation Cassegrain antenna according to the disclosure realizes good port isolation and radiation cross polarization characteristics by setting the main reflector, the secondary reflector and the diagonal horn feed, and by providing a special structure of the diagonal horn feed.
(2) A diagonal horn is used as a basic feed structure of the antenna in the dual-polarization high-isolation Cassegrain antenna according to the disclosure. The dual-polarization high-isolation Cassegrain antenna with dual-polarization characteristics is designed, so that the antenna feeds at two ports respectively to have almost identical radiation patterns, which has a good effect on improving detection sensitivity of the radar and consistency of two polarization detections.
(3) The dual-polarization high-isolation Cassegrain antenna according to the disclosure realizes good port matching through a structure of the second port, effectively reducing complexity of antenna debugging in a later stage.

### BRIEF DESCRIPTION OF THE DRAWINGS

Drawings are not intended to be drawn to scale. In the drawings, each identical or nearly identical component shown in various figures may be denoted by a same reference numeral. For a sake of clarity, not every component is labeled in every figure.

Embodiments of various aspects of the disclosure will now be described by way of example with reference to the drawings.

FIG. 1 is a structural schematic diagram of an embodiment of the disclosure.

FIG. 2 is a structural sectional view of an embodiment of the disclosure.

FIG. 3 is a first schematic diagram of structural details of a diagonal horn feed according to an embodiment of the disclosure.

FIG. 4 is a second schematic diagram of structural details of a diagonal horn feed according to an embodiment of the disclosure.

FIG. 5 is a schematic diagram of structural details of a diagonal horn feed according to an embodiment of the disclosure.

FIG. 6 is a fourth schematic diagram of structural details of a diagonal horn feed according to an embodiment of the disclosure.

FIG. 7 is a standing wave test diagram of a port 1 according to an embodiment of the disclosure.

FIG. 8 is a standing wave test diagram of a port 2 according to an embodiment of the disclosure.

FIG. 9 is a test diagram of port isolation according to an embodiment of the disclosure.

FIG. 10 is a test diagram of a port 1E plane pattern according to the embodiment of the disclosure.

FIG. 11 is a test diagram of a port 1H plane pattern according to an embodiment of the disclosure.

FIG. 12 is a test diagram of a port 2E plane pattern according to an embodiment of the disclosure.

FIG. 13 is a test diagram of a port 2H plane pattern according to an embodiment of the disclosure.

### DETAILED DESCRIPTION OF THE EMBODIMENTS

In order to better understand a technical content of the disclosure, specific embodiments are given and illustrated with drawings as follows.

In a description of the disclosure, it should be noted that terms “including”, “containing” or any other variation thereof are intended to cover non-exclusive inclusion, including not only those listed elements, but also other elements not explicitly listed.

In the description of the disclosure, it should be noted that an azimuth or positional relationship indicated by terms “center”, “upper”, “lower”, “left”, “right”, “vertical”, “inner” and “outer” are based on a azimuth or positional relationship shown in the attached drawings, and are only for a convenience of describing the disclosure and simplifying the description, rather than indicating or implying that a device or component referred to must have a specific orientation, specific directional construction and operation. Therefore, it may not be understood as a limitation on the disclosure. In addition, terms “first”, “second” and “third” are only used for descriptive purposes and may not be understood as indicating or implying relative importance.

### Embodiment 1: A Dual-Polarization High-Isolation Cassegrain Antenna Includes a Main Reflector 1, a Secondary Reflector 2 and a Diagonal Horn Feed 3

The diagonal horn feed 3 includes an integrated cross-polarization coupling-structure 8 and a diagonal horn protruding structure 10, where a hollow part of the diagonal horn protruding structure 10 is diagonal horn-shaped, and a horn opening is upward. An edge line 7 is arranged in the diagonal horn feed 3, and the edge line 7 passes through the diagonal horn protruding structure 10 and the cross-polarization coupling-structure 8.

The cross-polarization coupling-structure 8 includes a first port and a second port. The second port is located at a side surface of the diagonal horn feed, and its access is communicated with the edge line 7. The first port is located at a bottom surface of the diagonal horn feed, and its access is communicated with a bottom of the edge line 7.

In this embodiment, the main reflector 1 is a paraboloid and the secondary reflector 2 is a hyperboloid, and a focus of the main reflector 1 coincides with a focus of a curved surface of the secondary reflector 2. The diagonal horn feed 3 is located at a middle bottom of the main reflector 1, and a radiation phase center of the diagonal horn feed 3 is located at a common focus of the secondary reflector 1.

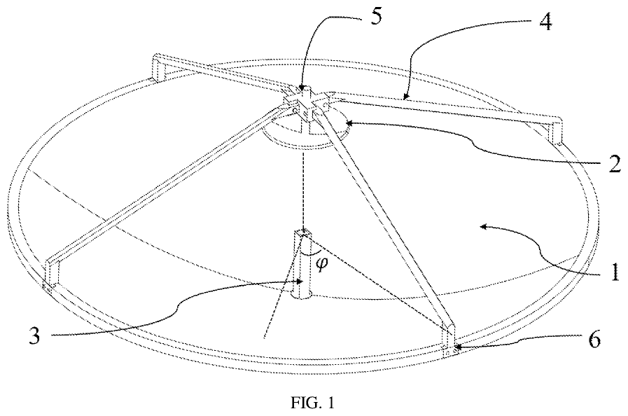

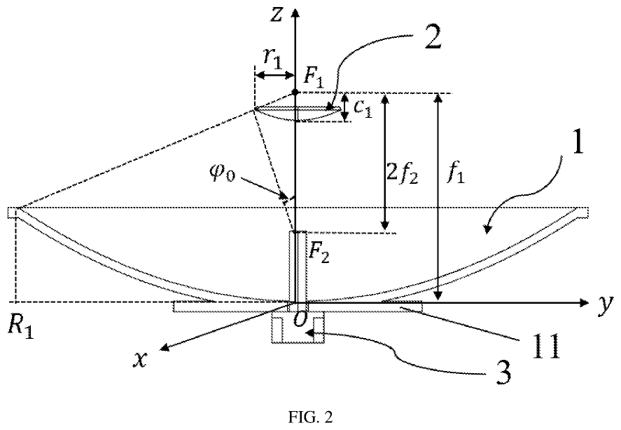

With reference to FIG. 1 and FIG. 2, in this embodiment, the secondary reflector is located above the main reflector and the feed, and its second focus coincides with a focus F2 of the main reflector. The radiation phase center of the diagonal horn feed is located at the first focus F1 of the secondary reflector. The diagonal horn feed 3 is located at the middle bottom of the main reflector 2. Optionally, it is fixedly attached to the main reflector 1 with screws.

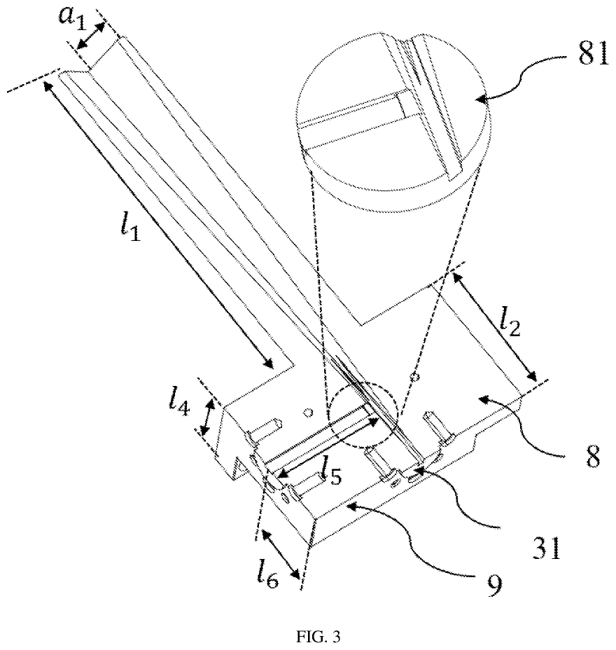

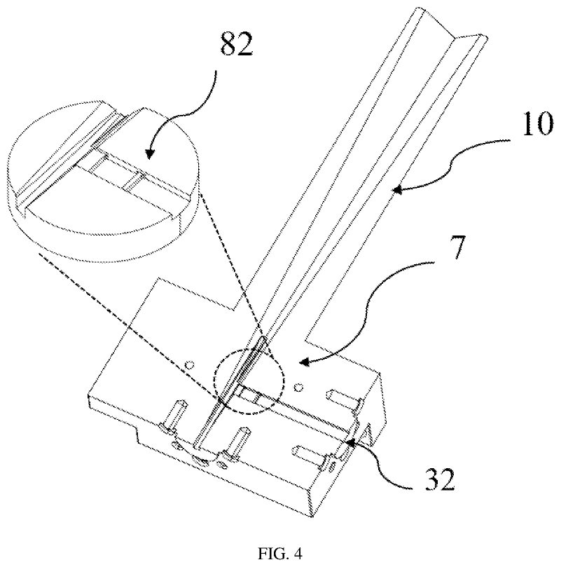

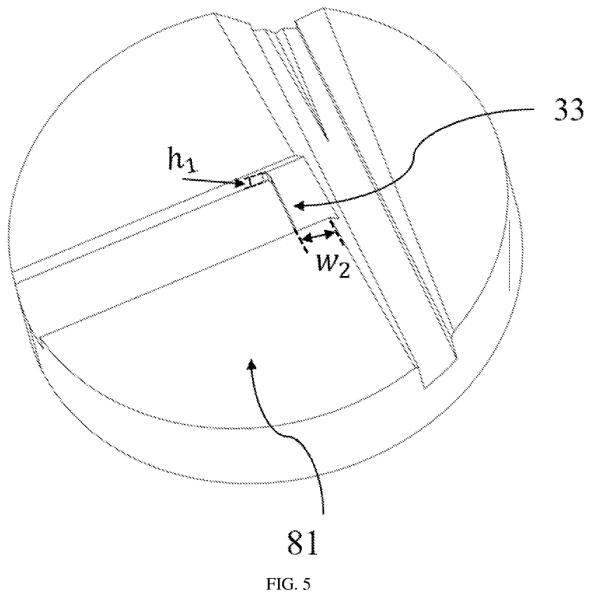

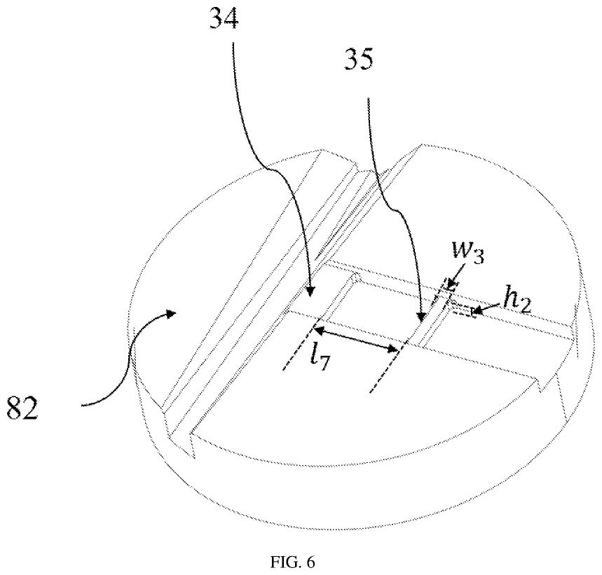

With reference to FIG. 3 and FIG. 4, the diagonal horn feeds the diagonal horn antenna, and two input ports are two mutually perpendicular incident ports using WR10 standard waveguide, namely the first port and the second port. A first port left profile 31 and a first port right profile 32 are shown in FIG. 3 and FIG. 4. A left profile of the access of the second port is provided with a matching structure 33 of a second port left profile, and a right profile of the access of the second port is provided with a first matching structure 34 of the second port right profile. A cross-polarization coupling-structure left profile 81 and a cross-polarization coupling-structure right profile 82 are shown in FIG. 5 and FIG. 6.

The access of the second port reduces an influence of the access of the second port on a current when the first port emits electromagnetic waves through the matching structure 33 of the second port left profile and the first matching structure 34 of the second port right profile. A method that the second port is connected to a feed horn through the matching structure 33 of the second port left profile and the first matching structure 34 of the second port right profile may effectively reduce an influence of the opening of the second port on the current of the first port, reduce an influence of the access of the second port on a radiation pattern of the diagonal horn feed 3, and facilitate a matching adjustment of the second port and an improvement of isolation between ports.

In other embodiments, a second matching structure 35 of the second port right profile is arranged at a set distance from the access of the second port, and good port matching is achieved by setting the matching structure at a certain distance from the access.

In this embodiment, the secondary reflector 2 is connected to a fixed disk 5, and the fixed disk 5 is connected to the main reflector 1 through a secondary reflector bracket structure 4.

The secondary reflector bracket structure 4 has four rhombic prisms, one end of each of the rhombic prisms is connected with the fixed disk 5, and an other end is connected with edge fixing points 6 of the main reflector 1. Optionally, an angle between each of the rhombic prisms and the edge line 7 of the diagonal horn feed 3 is φ=45°.

Further, in other embodiments, the diagonal horn feed 3 includes a part connected with a fixed bottom plate 11, and the fixed bottom plate 11 is used to install and fix the dual-polarization high-isolation Cassegrain antenna.

Parameter data in FIG. 2 is as follows. A radius R₁ of the main reflector 1=270 mm, a radius r₁ of the secondary reflector 2=41.5 mm, a focal length f₁ of the main reflector 1=201.8 mm, a focal length f₂ of the secondary reflector 2=66.8 mm, a distance c₁ from an apex of the secondary reflector 2 to the focus F₁=24.8 mm, and a beam angle width φ of the diagonal horn feed 3=20°.

Parameter dimension data in FIG. 3, FIG. 4, FIG. 5 and FIG. 6 are as follows. A side length al of the diagonal horn feed 3=9 mm, a length l₁ of the diagonal horn protruding structure 10=77.6 mm, a fixed length l₂ of feed installation for the cross-polarization coupling-structure 8=30 mm, a fixed width l₄ of the feed installation for the cross-polarization coupling-structure 8=10 mm, and a waveguide length l₅ of the second port 2=24.36 mm, a distance l₆ between the second port and a bottom surface 9 of the diagonal horn feed=13 mm, a distance l₇ between the matching structure 33 of the second port left profile and the edge line 7 is =4.27 mm, a height h₁ of the matching structure 33 of the second port left profile is 0.385 mm, a height h₂ of the second matching structure 35 of the second port right profile is 0.35 mm, a width w₂ of the matching structure 33 of the second port left profile is 1.04 mm, and a width w₃ of the second matching structure 35 of the second port right profile=0.4 mm. Optionally, the heights of the first matching structure 34 of the second port right profile and the second matching structure 35 of the second port right profile are the same, and the width of the first matching structure 34 of the second port right profile is greater than the width of the second matching structure 35 of the second port right profile.

A technical effect of the disclosure may be further illustrated by following performance tests.

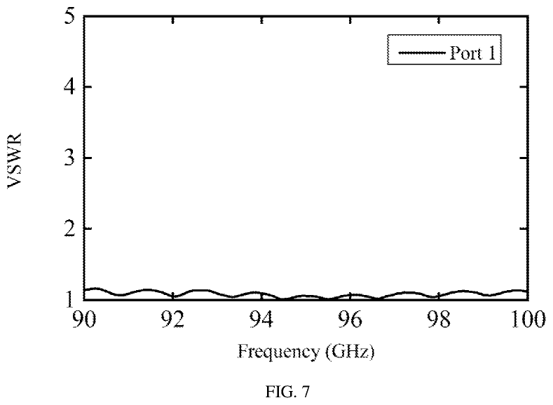

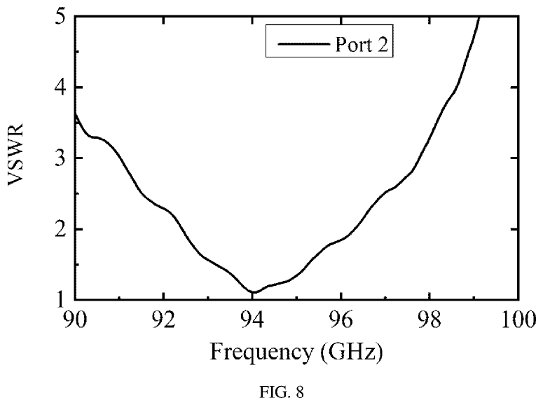

With reference to FIG. 7 and FIG. 8, standing wave test results of a first port and a second port of a physical diagonal horn feed 3 are shown. A standing wave ratio of the second port is less than 1.5:1 in a range of 93.2-95.3 GHz, and a first port is well matched in a whole frequency band of 90-100 GHz.

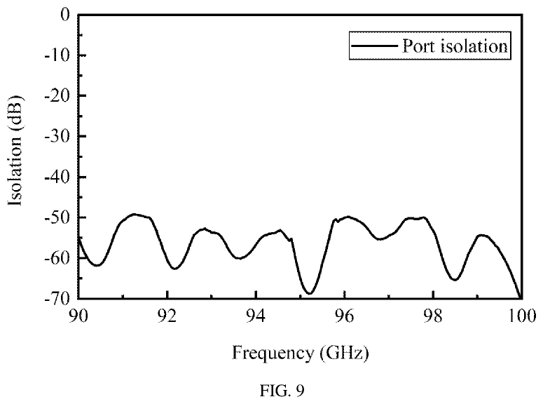

With reference to FIG. 9, test results of isolation between a first port and a second port of a physical diagonal horn feed 3 are shown. In a range of 93.2-95.3 GHz, the isolation between the two ports is greater than 50 dB.

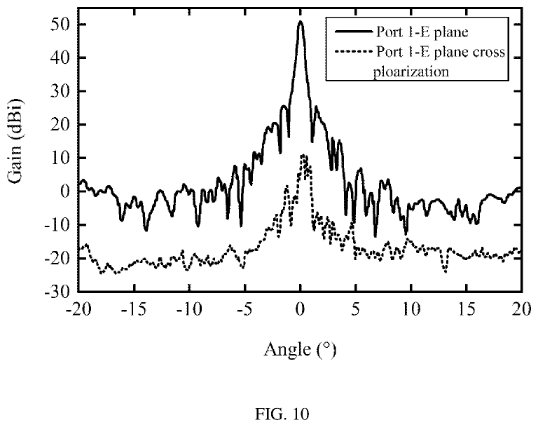

With reference to FIG. 10, test results of a radiation pattern of an E plane of a first port of a physical dual-polarization high-isolation Cassegrain antenna are shown. A gain of the antenna is 50.85 dB, a sidelobe is −25.2 dB, a 3 dB beam width is 0.42°, and cross polarization is better than 39 dB.

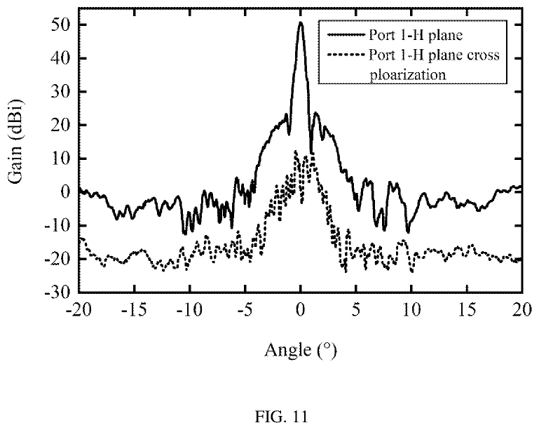

With reference to FIG. 11, test results of a radiation pattern of an H plane of a first port of a physical dual-polarization high-isolation Cassegrain antenna are shown. A gain of the antenna is 50.85 dB, a sidelobe is −26 dB, a 3 dB beam width is 0.415°, and cross polarization is better than 37 dB.

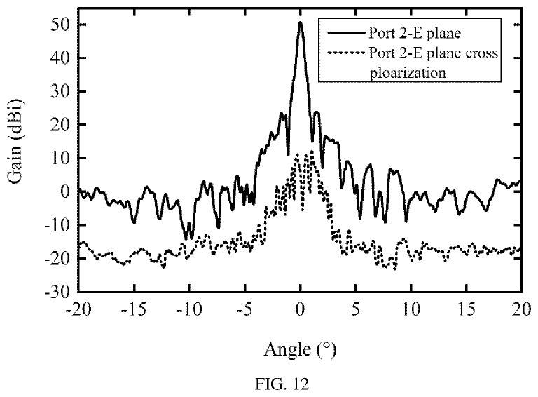

With reference to FIG. 12, test results of a radiation pattern of an H plane of a second port of a physical dual-polarization high-isolation Cassegrain antenna are shown. A gain of the antenna is 50.85 dB, a sidelobe is −26 dB, a 3 dB beam width is 0.42°, and cross polarization is better than 37 dB.

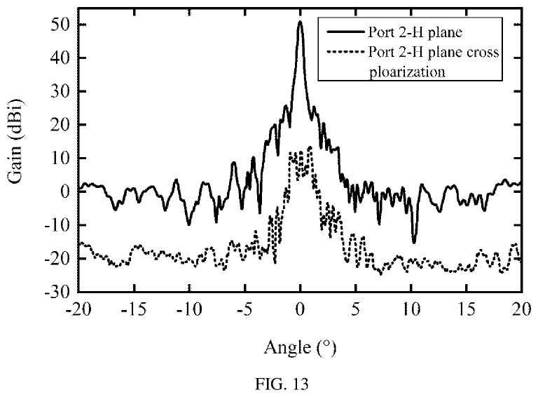

With reference to FIG. 13, test results of a radiation pattern of an H plane of a second port of a physical dual-polarization high-isolation Cassegrain antenna are shown. A gain of the antenna is 50.85 dB, a sidelobe is −25.5 dB, a 3 dB beam width is 0.42°, and cross polarization is better than 37 dB.

With reference to FIGS. 7-13, test results of a radiation pattern of a dual-polarization high-isolation Cassegrain antenna are shown. Standing waves and the isolation of the first port and the second port meet engineering technical requirements of an application background of the disclosure, and the test results of the radiation patterns of the E plane and the H plane of the two ports of the antenna are consistent, which is in line with an original design intention of the disclosure.

Although the disclosure has been disclosed in terms of preferred embodiments, it is not intended to limit the disclosure. Those who have ordinary knowledge in the technical field to which this disclosure belongs may make various changes and embellishments without departing from a spirit and a scope of this disclosure. Therefore, a scope of protection of the disclosure should be determined by claims.

What is claimed is:

1. A dual-polarization high-isolation Cassegrain antenna, comprising a main reflector, a secondary reflector and a diagonal horn feed; the diagonal horn feed comprises an integrated cross-polarization coupling-structure and a diagonal horn protruding structure, wherein a hollow part of the diagonal horn protruding structure is diagonal horn-shaped, and a horn opening is upward; an edge line is arranged in the diagonal horn feed, and the edge line passes through the diagonal horn protruding structure and the cross-polarization coupling-structure;
the cross-polarization coupling-structure comprises a first port and a second port; the second port is located at a side surface of the cross-polarization coupling-structure, and its access is communicated with a side of the edge line; the first port is located at a bottom surface of the cross-polarization coupling-structure, and is communicated with a bottom of the edge line.

2. The dual-polarization high-isolation Cassegrain antenna according to claim 1, wherein an access of a second port left profile is provided with a matching structure of the second port left profile, and an access of a second port right profile is provided with a first matching structure of the second port right profile.

3. The dual-polarization high-isolation Cassegrain antenna according to claim 2, wherein a second matching structure of the second port right profile is arranged at a set distance from the access of the second port on the second port right profile.

4. The dual-polarization high-isolation Cassegrain antenna according to claim 1, wherein the secondary reflector is connected to a fixed disk, and the fixed disk is connected to the main reflector through a secondary reflector bracket structure.

5. The dual-polarization high-isolation Cassegrain antenna according to claim 4, wherein the secondary reflector bracket structure has four rhombic prisms, one end of each of the rhombic prisms is connected with the fixed disk, and an other end is connected with an edge of the main reflector.

6. The dual-polarization high-isolation Cassegrain antenna according to claim 1, wherein the diagonal horn feed comprises a part connected with a fixed bottom plate, and the fixed bottom plate is used to install and fix the dual-polarization high-isolation Cassegrain antenna.

7. The dual-polarization high-isolation Cassegrain antenna according to claim 1, wherein a side length of a horn in the diagonal horn protruding structure is set to 9 mm.

8. The dual-polarization high-isolation Cassegrain antenna according to claim 1, wherein a length of the diagonal horn protruding structure is set to 77.6 mm.

9. The dual-polarization high-isolation Cassegrain antenna according to claim 1, wherein a waveguide length of the second port is set to 24.36 mm.

10. The dual-polarization high-isolation Cassegrain antenna according to claim 1, wherein a distance between the second port and a bottom surface of the diagonal horn feed is 13 mm.
